(19) United States
(12) Patent Application Publication
(10) Pub. No.: US 2026/0111864 A1
(43) Pub. Date: Apr. 23, 2026

(54) System and Method for Multi-Billing Integration and Third-Party Data Exchange in Broadband

(71) Applicant: Jason Yaker, Boulder, CO (US)

(72) Inventor: Jason Yaker, Boulder, CO (US)

(21) Appl. No.: 19/363,235

(22) Filed: Oct. 20, 2025

Related U.S. Application Data
(60) Provisional application No. 63/709,894, filed on Oct. 21, 2024.

(51) Int. Cl. G06Q 20/14; G06Q 20/08; H04L 9/40

(52) U.S. Cl. CPC G06Q 20/14; G06Q 20/0855; H04L 63/101

(57) ABSTRACT

Disclosed are a system and method for integrating a plurality of disparate enterprise software systems to provide a unified data layer for managing bi-directional data exchange with third-party entities. In an exemplary embodiment within the broadband industry, the system integrates multiple billing systems. The system provides a unified access point through a dynamic integration framework for connecting to the plurality of disparate systems, a data normalization engine for standardizing disparate data, and a secure third-party integration module for managing vendor access. In some embodiments, the system further includes a conflict resolution system to detect and resolve data discrepancies to assure data integrity. The system streamlines operations, improves data accuracy, and enhances service delivery by enabling rapid integration of new systems and supporting data-driven decisions.

### CROSS-REFERENCE TO RELATED APPLICATIONS

This application claims priority to U.S. Provisional Application No. 63/709,894, filed Oct. 21, 2024

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING APPENDIX SUBMITTED ON ELECTRONIC MEDIUM (IF APPLICABLE)

Not applicable.

### BACKGROUND OF THE INVENTION

Field of the Invention: The present invention relates generally to the field of data processing, and more specifically, to systems and methods for integrating a plurality of disparate enterprise software systems to create a unified data layer and manage data exchange. Such disparate systems may include, without limitation, Business Support Systems (BSS), Operations Support Systems (OSS), Customer Relationship Management (CRM) systems, Enterprise Resource Planning (ERP) systems, and other platforms that act as sources of record. While the principles of the invention are broadly applicable across various industries, the specification describes an exemplary embodiment within the broadband telecommunications industry for integrating billing systems.

Need for the Invention: In the broadband industry, service providers often utilize a multitude of billing systems, each with unique data formats, communication protocols, and functionalities. This heterogeneity creates significant challenges in: (1) aggregating and analyzing data from multiple sources; (2) maintaining data consistency across systems; (3) integrating with external vendors for services such as marketing, customer support, payments, and provisioning. Existing solutions are often manual, time-consuming, error-prone, or lack scalability. Furthermore, while general-purpose middleware or Enterprise Application Integration (EAI) platforms exist for data transformation, they are often ill-equipped to handle the complex, real-time data integrity challenges inherent in multi-source, bi-directional environments. Specifically, they typically lack automated, intelligent mechanisms for resolving data conflicts that arise when data can be edited from multiple sources simultaneously. This forces a reliance on separate, after-the-fact data reconciliation processes, which are themselves complex and fail to prevent data corruption in real-time. They do not provide a standardized, automated approach for managing data across diverse billing systems and external parties.

### SUMMARY OF THE INVENTION

The present invention addresses the above-mentioned challenges by providing a system and method for multi-billing integration and third-party data exchange in broadband. Generally, the invention encompasses a software gateway operable to interface with a plurality of billing systems, facilitating the transformation of data into normalized communications for interaction with third-party vendors. This provides for an ecosystem characterized by scalable integrations and efficient, accurate information flow. Illustrative, non-limiting components and functionalities may include a dynamic integration framework, a data normalization engine, a secure third-party integration module, a real-time event processing engine, a conflict resolution mechanism, and support for third-party billing. A key aspect of the invention is the deep integration of the conflict resolution mechanism with the real-time event processing engine, creating a system that not only transforms and transmits data but also actively and preemptively ensures its integrity during bi-directional exchanges. It is understood that the invention is not restricted to the precise configuration or inclusion of all these elements, and various permutations and subsets thereof are considered within the scope of the invention.

### BRIEF DESCRIPTION OF THE SEVERAL VIEWS OF THE DRAWING (IF APPLICABLE)

FIG. 1 is a system architecture diagram illustrating the overall components of the multi-billing integration and third-party data exchange system.

FIG. 2 is a flowchart illustrating the data normalization process.

FIG. 3 is a flowchart illustrating the method of data pushing to third party systems with configurable rules

FIG. 4 is a flowchart illustrating the method of detecting and resolving data conflicts

### DETAILED DESCRIPTION OF THE INVENTION

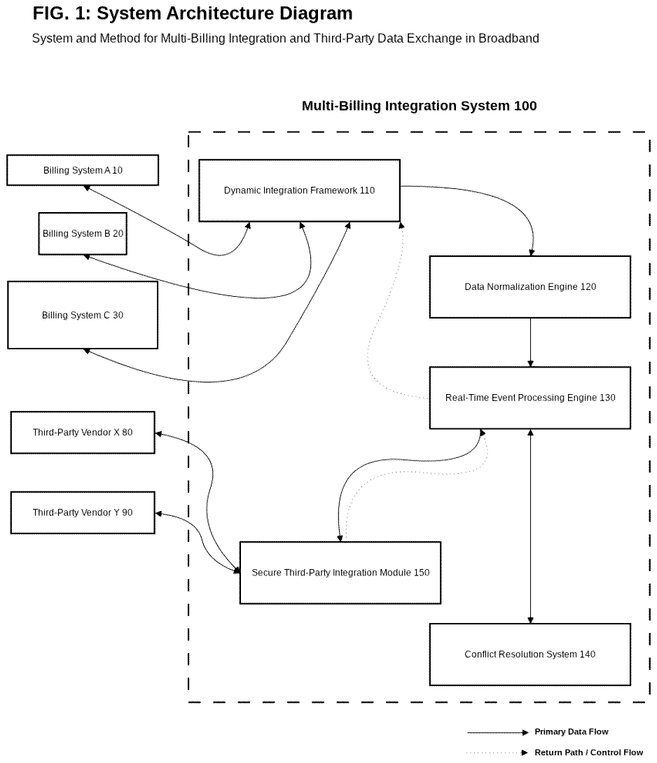

The present invention provides a comprehensive software system for integrating multiple billing platforms and managing data exchange with external vendors. In an illustrative embodiment, and with reference to FIG. 1, the system may comprise several key components, including, but not limited to:

Central Gateway Server: The system may include at least one gateway server configured to function as a main entry point for requests by providing authentication, authorization, and request routing. In some embodiments, this functionality may be implemented as a single, central server, while in other embodiments, it may be distributed across multiple server instances or microservices.

Dynamic Integration Framework (110): A set of customizable components enabling secure connections with billing systems, handling data interaction based on each system's unique communications. These components can include API connectors, webhook receivers, message queue listeners, and any other suitable data communication interfaces, whether now known or developed in the future, capable of establishing a data communication channel with an external system.

Data Normalization Engine (120): Transforms data from disparate billing systems into a standardized format. This component may be a single entity or multiple entities and may take place within any portion of the framework or as a stand alone component(s).

Real-Time Event Processing Engine (130): Allows for many-to-one communications, reading and writing data to connected billing systems in real-time, such as through API connectors, webhooks, message queue listeners, or other suitable technologies. A primary function of the Real-Time Event Processing Engine (130) is to orchestrate the bi-directional flow of data. Critically, this includes identifying events that represent a potential data conflict (such as a write operation from a third-party) and acting as the trigger for invoking the Conflict Resolution System (140) as an integral part of the data processing workflow

In various embodiments, the system is configured to operate in a bi-directional manner to handle both reading data from and writing data back to the billing systems, as illustrated.

Secure Third-Party Integration Module (150): Enables authorized vendors to access standardized data through a defined, secure path, managed through configurable rules and permissions.

Conflict Resolution System (140): Intelligent algorithms that can detect and resolve conflicts in cases where data can be edited from multiple source systems. The system employs version control, relies on a rule-based system for determining record preservation, manages rollbacks, creates an audit trail, and facilitates reconciliation to maintain data integrity. Unlike traditional data reconciliation systems which may operate periodically or as a separate, after-the-fact process, the Conflict Resolution System (140) of the present invention is configured to be invoked in-line and in real-time by the Real-Time Event Processing Engine (130). This proactive approach prevents data corruption before it is propagated back to the source systems.

As used herein, the term ‘standardized data format’ refers to any common data structure into which data from disparate systems can be mapped. Illustrative, non-limiting examples of such a format may include a defined JSON (JavaScript Object Notation) schema, a custom XML (eXtensible Markup Language) definition, a protocol buffer, or any other structured data format suitable for ensuring consistency across the system

### Forward Data Flow (Reading From Billing Systems)

Data is read from the Billing Systems (10, 20, 30) and flows into the system via the Dynamic Integration Framework (110). This raw data is passed along the primary data path, indicated by solid-line arrows, to the Data Normalization Engine (120) where it is transformed into a standardized format. The normalized data is then managed by the Real-Time Event Processing Engine (130) and made securely available to authorized Third-Party Vendors (80, 90) via the Secure Third-Party Integration Module (150).

### Return Data Flow (Writing Back to Billing Systems)

The system also manages updates originating from third parties. This return data and control flow is indicated by double-headed and dotted-line arrows.

In an exemplary return operation, a Third-Party Vendor (80) sends a data update (e.g., a new customer address) to the Secure Third-Party Integration Module (150). After authenticating the vendor and authorizing the request, the module passes the standardized update to the Real-Time Event Processing Engine (130), as shown by the dotted-line arrow.

The Real-Time Event Processing Engine (130) orchestrates the update. It first consults the Conflict Resolution System (140) to ensure data integrity. This tight coupling, wherein the engine proactively verifies and resolves conflicts before issuing a command to the Dynamic Integration Framework (110), represents a significant and non-obvious improvement over conventional integration platforms. It ensures that only a single, validated, ‘golden record’ version of the data is ever written back to the source systems, thereby preventing data corruption at its origin rather than merely detecting it later. Once cleared, the engine sends a command, shown by the second dotted-line arrow, to the Dynamic Integration Framework (110).

The Dynamic Integration Framework (110) receives the standardized update and the command. It then performs a “reverse translation,” converting the standardized data back into the unique, native format required by each individual Billing System (10, 20, 30). Finally, it writes this native data back to the billing systems, as indicated by the double-headed arrows connecting the framework to the billing systems. This ensures that updates from a single third-party source are accurately and consistently propagated across the entire heterogeneous billing environment.

For example, in one embodiment, a third-party marketing vendor updates a customer's email address via the secure module. The real-time event processing engine processes this event. Simultaneously, a customer service representative attempts to update the same email in a legacy billing system. The conflict resolution system, referencing its rules which prioritize vendor-sourced data, preserves the vendor's update, creates an audit log of the attempted concurrent modification, and propagates the corrected, standardized data back to all connected billing systems.

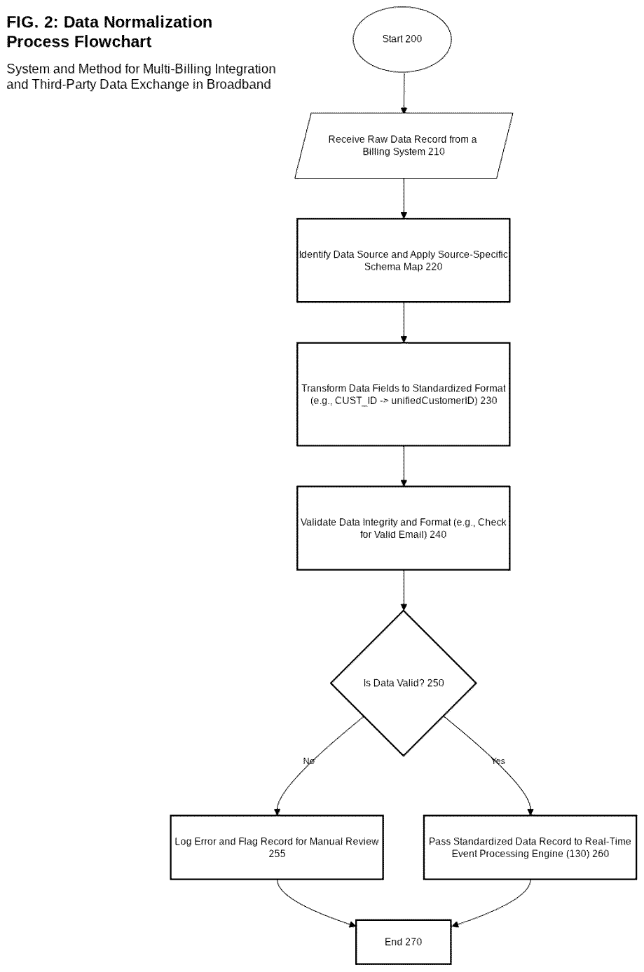

### FIG. 2

The data normalization process, performed by the Data Normalization Engine (120), is further detailed in the flowchart of FIG. 2. One exemplary process flow is illustrated in this figure. In this embodiment, the process may begin at start (200) and proceed to step 210, where a raw data record is received from one of the plurality of billing systems. At step 220, the system identifies the source of the data and applies a source-specific schema map to understand its structure. At step 230, the data fields are transformed from their native format into the system's standardized format, for example, converting a field named CUST_ID into unifiedCustomerID.

Following transformation, in some embodiments, the data's integrity and format may be validated at step 240. A decision is made at step 250 as to whether the data is valid. If the data is not valid, the “No” path is taken to step 255, where the error is logged and the record is flagged for manual review before the process ends. If the data is valid, the “Yes” path is taken to step 260, where the now-standardized data record is passed to the Real-Time Event Processing Engine (130) for further processing. The process then concludes at end (270).

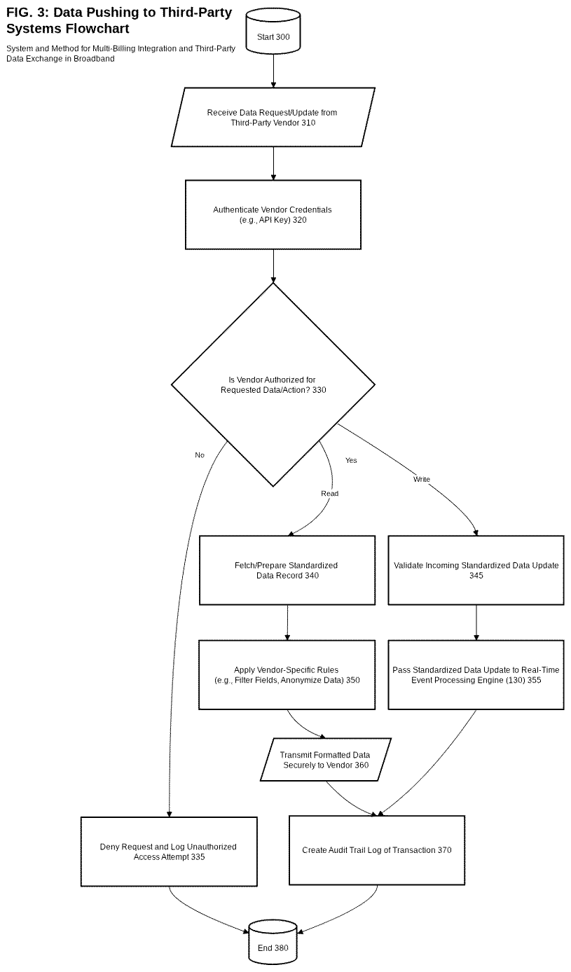

### FIG. 3

The process flow for the Secure Third-Party Integration Module (150). The process starts at (300) when the module receives a data request or a data update from a third-party vendor at step 310. At step 320, the identity of the third-party vendor is authenticated. This authentication process may, for example, involve validating an API key, checking a digital certificate, verifying OAuth tokens, or any other suitable method for confirming identity, followed by a decision at step 330 to determine if the vendor is authorized for the requested action. If not, the request is denied at step 335. If the vendor is authorized, a second decision is made at step 338 to determine if the request is for a data read or a data write.

If the request is a “Read,” the system proceeds to step 340 to fetch the relevant standardized data. At step 350, any vendor-specific rules, such as data filtering, are applied before the formatted data is securely transmitted to the vendor at step 360.

If the request is a “Write,” the system proceeds to step 345 to validate the incoming standardized data update. At step 355, the validated update is passed to the Real-Time Event Processing Engine (130) to be propagated back to the billing systems.

Following either a successful read or write operation, both paths converge at step 370, where an audit trail log of the transaction is created before the process concludes at end (380).

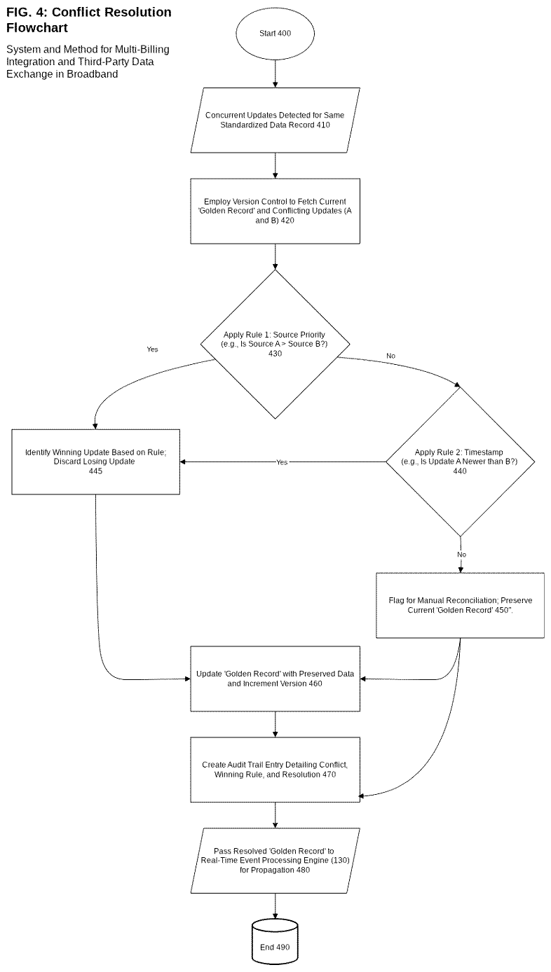

### FIG. 4

The detailed flowchart of the Conflict Resolution System (140). The process initiates at start (400) upon the detection of concurrent updates for the same data record at step 410. At step 420, the system fetches the current “golden record” along with the conflicting updates. The system then applies a series of ordered rules to resolve the conflict. At decision 430, a rule based on source priority is applied. If this rule resolves the conflict, the “Yes” path is taken. If not, the “No” path leads to decision 440, where a second rule based on the update timestamp is applied.

If either rule determines a winning update, the process moves to step 445, where the winning update is identified and the losing one is discarded. The “golden record” is then updated with the winning data at step 460. If no rule can resolve the conflict, the “No” path from the final decision (440) is taken to step 450, where the record is flagged for manual reconciliation and the current “golden record” is preserved.

Regardless of the outcome, both paths converge at step 470, where a detailed audit trail of the conflict and its resolution is created. In the final and crucial step of the process, step 480, the resolved (either updated or preserved) “golden record” is passed back to the Real-Time Event Processing Engine (130). This ensures the correct and consistent version of the data is propagated across all connected billing systems and third-party vendors. The process then concludes at end (490).

### Alternative Embodiments

It is to be understood that the invention is not limited to the precise configuration and components described above. For example, in some embodiments, the functions of the Data Normalization Engine (120) and the Real-Time Event Processing Engine (130) may be implemented as a set of distributed microservices rather than as monolithic components. In another embodiment, the Conflict Resolution System (140) may employ machine learning or artificial intelligence algorithms to predict and resolve data conflicts, in addition to or in place of the static rule-based system described. Furthermore, the Dynamic Integration Framework (110) may connect to other types of enterprise systems beyond billing systems, such as Customer Relationship Management (CRM) or Enterprise Resource Planning (ERP) systems, without departing from the scope of the invention.

1. A system for multi-billing integration and third-party data exchange, the system comprising:
a processor and a memory storing instructions;
the instructions, when executed by the processor, configure the system to comprise:
a dynamic integration framework configured to establish data communication channels with a plurality of disparate billing systems;
a data normalization engine configured to transform data received from the plurality of billing systems via the data communication channels into a standardized data format;
a secure third-party integration module configured to provide controlled access for one or more third-party entities to the standardized data, wherein said access is governed by a set of configurable rules; and
a real-time event processing engine configured to manage bi-directional data exchange between the plurality of billing systems and the one or more third-party entities.

2. The system of claim 1, further comprising a conflict resolution system configured to detect and resolve data discrepancies that arise in the standardized data.

3. The system of claim 1, wherein the dynamic integration framework comprises customizable components configured for inter-system data exchange, said components selected from the group consisting of API connectors, webhook receivers, message queue listeners, and other suitable data communication interfaces.

4. The system of claim 3, wherein the customizable components are configured to handle data interaction based on unique data requirements of each connected billing system.

5. The system of claim 1, wherein the secure third-party integration module is further configured to validate client access permissions to specific data fields or functionalities using at least one method selected from the group consisting of: a field-level permissions system, a role-based access control system, and a policy-based access control system.

6. The system of claim 2, wherein the conflict resolution system is configured to:
employ version control to determine changes in data records; and
rely on a rule-based system for determining which data record to preserve, based on an ordered evaluation, to handle exceptions.

7. The system of claim 6, wherein the conflict resolution system is further configured to:
create an audit trail for detected data discrepancies and their resolutions; and
reconcile conflicts before transmitting data to external data locations.

8. A method for multi-billing integration and third-party data exchange, the method comprising: establishing, via a dynamic integration framework, data communication channels with a plurality of disparate billing systems; transforming, via a data normalization engine, data received from the plurality of billing systems into a standardized data format; providing controlled access for one or more third-party entities to the standardized data via a secure third-party integration module, wherein said access is governed by a set of configurable rules; and managing, via a real-time event processing engine, bi-directional data exchange between the plurality of billing systems and the one or more third-party entities.

9. The method of claim 8, further comprising detecting and resolving, via a conflict resolution system, data discrepancies that arise in the standardized data.

10. The method of claim 8, wherein establishing the data communication channels comprises utilizing customizable components configured for inter-system data exchange, said components selected from the group consisting of API connectors, webhook receivers, message queue listeners, and other suitable data communication interfaces.

11. The method of claim 10, wherein utilizing customizable components comprises handling data interaction based on unique data requirements of each connected billing system.

12. The method of claim 8, wherein providing controlled access comprises validating client access permissions to specific data fields or functionalities using at least one method selected from the group consisting of:
a field-level permissions system, a role-based access control system, and a policy-based access control system.

13. The method of claim 9, wherein detecting and resolving data discrepancies comprises:
employing version control to determine changes in data records; and
relying on a rule-based system for determining which data record to preserve, based on an ordered evaluation, to handle exceptions.

14. The method of claim 13, wherein detecting and resolving data discrepancies further comprises:
creating an audit trail for detected data discrepancies and their resolutions; and
reconciling conflicts before transmitting data to external data locations.

15. A non-transitory computer-readable medium storing instructions that, when executed by one or more processors, cause the one or more processors to perform a method comprising: establishing, via a dynamic integration framework, data communication channels with a plurality of disparate billing systems; transforming, via a data normalization engine, data received from the plurality of billing systems into a standardized data format; providing controlled access for one or more third-party entities to the standardized data via a secure third-party integration module, wherein said access is governed by a set of configurable rules; and managing, via a real-time event processing engine, bi-directional data exchange between the plurality of billing systems and the one or more third-party entities.

16. The non-transitory computer-readable medium of claim 15, the method further comprising detecting and resolving, via a conflict resolution system, data discrepancies that arise in the standardized data.

17. The non-transitory computer-readable medium of claim 15, wherein establishing the data communication channels comprises utilizing customizable components configured for inter-system data exchange, said components selected from the group consisting of API connectors, webhook receivers, message queue listeners, and other suitable data communication interfaces.

18. The non-transitory computer-readable medium of claim 17, wherein utilizing customizable components comprises handling data interaction based on unique data requirements of each connected billing system.

19. The non-transitory computer-readable medium of claim 15, wherein providing controlled access comprises validating client access permissions to specific data fields or functionalities using at least one method selected from the group consisting of: a field-level permissions system, a role-based access control system, and a policy-based access control system.

20. The non-transitory computer-readable medium of claim 16, wherein detecting and resolving data discrepancies comprises:
employing version control to determine changes in data records; and
relying on a rule-based system for determining which data record to preserve, based on an ordered evaluation, to handle exceptions.

21. The non-transitory computer-readable medium of claim 20, wherein detecting and resolving data discrepancies further comprises:
creating an audit trail for detected data discrepancies and their resolutions; and
reconciling conflicts before transmitting data to external data locations.
